(19) United States
(12) Patent Application Publication
(10) Pub. No.: US 2008/0313960 A1
(43) Pub. Date: Dec. 25, 2008

(54) MOBILE PLANTER

(76) Inventor: Daniel A. Norvitch, Boise, ID (US)

Correspondence Address: PEDERSEN & COMPANY, PLLC, P.O. BOX 2666, BOISE, ID, 83701, US

(21) Appl. No.: 12/133,262

(22) Filed: Jun. 4, 2008

Related U.S. Application Data
(60) Provisional application No. 60/944,857, filed on Jun. 19, 2007.

(51) Int. Cl. A01G 25/00

(52) U.S. Cl. 47/79; 47/70

(57) ABSTRACT

A mobile gardening planter includes a plant container and a drainage system that is adapted for both dripless operation and drip-drain operation. The drainage system includes a drain cap inside the plant container that has holes preferably only in a vertical side of the drain cap for indirectly draining water out of the plant container into a drain pipe extending outside and across the bottom wall of the plant container. A generally vertically-extending sight tube fluidly communicates with the drain pipe so that the water level in the sight tube is the same as the water table level in the plant container, and the gardener may therefore monitor the water table. The open top end of the sight tube allows water to overflow the sight tube, to prevent undesirable over-watering. The sight tube is preferably shielded by a portion of the planter, and most preferably a portion of the frame, that extends outward from the plant container farther than does the sight tube. Openable cleanouts in the drainage system may be used to eliminate the water table or to flush and clean out the drain pipe assembly and/or the plant container. A plant support may be installed directly above the plant container for supporting the limbs and branches of the plant growing therein.

This application claims priority of U.S. Provisional Application Ser. No. 60/944,857, filed Jun. 19, 2007, entitled “Mobile Planter,” the entire disclosure of which is hereby incorporated herein by this reference.

### BACKGROUND OF THE INVENTION

1. Field of the Invention

The present invention generally relates to plant husbandry and more specifically relates to planters used for container gardening.

2. Related Art

Gardeners who practice container gardening can choose from many traditional planters of various shapes, sizes, and aesthetic styles to accomplish their gardening goals. Traditional planters are basically containers for holding potting soil that have at least one water drain hole in the bottom surface of the container. Traditional planters usually come with deficiencies, which experienced gardeners frequently address by home remedies such as partially-blocking drain holes and/or adding water-catching trays, as will be discussed later in this document.

Traditional window boxes for flowers are similar to traditional planters in that they comprise soil containers with one or more drain holes in the bottom wall of the container. Many, however, comprise a side-trough protruding from the side of the soil container in a direction intended to be away from the window or wall. Water draining from the soil container hole(s) enters the open-topped side-trough and overflows, allowing very little or no water table in the container due to the shallow depth of the side-trough. Examples of such boxes with side-troughs are disclosed in Bolger (U.S. Pat. No. 1,116,227, issued Nov. 3, 1914) and Piaget (U.S. Pat. No. 187,771, issued Feb. 27, 1877).

Alternatives to traditional planters and window boxes have been designed with features aimed at more reliable catching of drained water and/or automatic watering. Such alternatives, however, are typically complex, difficult to clean, unaesthetic, and/or have moveable parts that are prone to becoming fouled or unworkable. Examples of such alternative planters/boxes are disclosed in the patent literature as follows.

The patent literature discloses planters with various proposed means of controlling or monitoring water level inside the soil. Such U.S. patents include Bloch (U.S. Pat. No. 4,991,345, issued Feb. 12, 1991), which comprises a spout and siphon tube system for first filling the plant container with water and then draining the water, which flows from the container to a basin, to a level outside the container and lower than said basin. Ellis-El (U.S. Pat. No. 5,596,839, issued Jan. 28, 1997) discloses a double-walled planter wherein an inner wall contains the plant and soil and a cavity extending all the way around said inner wall, between said inner wall and an outer wall, holds water and conveys water to the soil through a sponge portion of the inner wall. A water level indicator in the Ellis-El outer wall allows one to view the water level in the cavity, and a sprayer draws water from the cavity for spraying the plant. Carlson (U.S. Pat. No. 3,243,919, issued Apr. 5, 1966) discloses a plant receptacle with a transparent panel in the outer wall of the receptacle, said panel having horizontal scale markings.

Many patents disclose moving float systems for indicating water level inside a planter. For example, Hess (U.S. Pat. No. 124,207, issued Mar. 5, 1872); Joswig, et al. (U.S. Pat. No. 4,420,904, issued Dec. 20, 1983); and Scannel, Jr. (U.S. Pat. No. 6,279,265, issued Aug. 28, 2001) disclose elongated, light-weight sticks and/or float balls provided in compartments separate from the soil. The sticks/balls rise with the water level to be visible to the gardener above, or at an upper region, of the planter.

Other patents disclose tubing systems wherein watering and/or drainage tubes are placed in the soil. For example, De Filippi (U.S. Pat. No. 5,209,015, issued May 11, 1993) and Andrews (U.S. Pat. No. 5,299,384, issued Apr. 5, 1994) disclose watering or drainage tubes placed inside soil or gravel, wherein the tubes have holes or screened fluid-porous material portions that allow fluid flow. The Andrews patent discloses swinging of the end of its L-shaped drainage tube up or down inside the plant receptacle to “preselect” the water level inside the plant receptacle; such an adjustment, however, would require the plant receptacle to be emptied or nearly-emptied of soil in order to swing the drainage tube.

Whisenant (U.S. Pat. No. 5,524,387, issued Jun. 11, 1996), Geraldson (U.S. Pat. No. 6,332,287, issued Dec. 25, 2001) and Atkinson, et al. (U.S. Pat. No. 7,059,367, issued Jun. 13, 2006) each disclose planters that have features in common with the Earthbox™ planters currently available in the marketplace. Such planters may be described as having multiple interior compartments in their plant containers, wherein at least one compartment is for holding soil and plants and at least one compartment is for holding only water. The water reservoir is below the soil compartment and separated from the soil compartment by a perforated horizontal plate. The water reservoir covers most of the bottom wall of the plant container, typically all of the bottom wall except for one or more small corner zones wherein soil extends all the way to the bottom wall. The Earthbox™ planter is adapted for being watered through a generally vertical tube that fluidly communicates with said water reservoir, wherein continued watering fills the water reservoir and then causes water overflow down through a hole in an inwardly-extending, horizontal shelf or “shoulder” of the plant container wall near the bottom of the planter container. A gardener cannot easily see this hole, and so only knows when the water reservoir is full when water drips or runs out from underneath the Earthbox™.

Still, with respect to the related art, there is a need for an improved planter for gardeners that allows efficient watering, water level indication, and drainage options that allow complete drainage of, or creation of beneficial limited water tables in, the planter by effective and economic means. There is a need for such a planter that may be cleaned and maintained easily and that has few or no moving parts. The preferred embodiment of the invention meets all of these needs, and does so with the water level indication and drainage options, including drain cleanout capabilities, being provided by light-weight and inconspicuous equipment that does not overwhelm the preferred simple and aesthetically-pleasing lines of the planter.

### SUMMARY OF THE INVENTION

An object of the present invention is to remedy the deficiencies of traditional planters and provide additional features to allow the gardener to grow plants in containers that rival the quality of plants grown in the ground. The present invention is a planter that comprises a container for soil and plants and a drainage system that provides indirect drainage from the container to achieve soil retention. The drainage system comprises options for both complete drainage of, or creation of beneficial limited water tables in, the planter. Preferably, these options are provided by said drainage system comprising a lower water outlet, and an upper water outlet, which are below, and above, the bottom wall of the container, respectively. Said lower water outlet may be partially or completely opened to fully drain excess water from the container, in the event that the gardener desires no water table inside the container. Said lower water outlet may be closed to allow a water table to be established in the container, which water table may rise at most to the level of the upper water outlet.

The preferred drainage system extends through a bottom wall of the container and to an outer sidewall of the container. The preferred drainage system is a generally U-shaped conduit, with a generally vertical inner portion inside the container, a generally horizontal portion extending underneath the container, and a generally vertical outer portion upending along the outer sidewall. The drainage system may be made substantially from easily-available commercial plumbing components and is small, light-weight and visually—inconspicuous compared to the large container.

The preferred generally vertical inner portion of the generally U-shaped conduit comprises a cap with a solid, non-perforated top surface, and a perforated vertical side surface. The non-perforated top surface blocks vertical, direct draining of water out of the container, while the perforated vertical side surface allows horizontal, indirect draining of water out of the container. Thus, the preferred cap tends to prevent soil loss.

The preferred generally horizontal portion of the generally U-shaped conduit has a plurality of cleanouts, wherein the cleanouts are preferred embodiments of said lower water outlet. The cleanouts are openable for completely draining the container and may be used for flushing out the drainage system or container.

The preferred generally vertical outer portion of the generally U-shaped conduit is a tube having an open end at a level above the bottom wall of the container, wherein said open end is the uppermost extremity of the drainage system and the preferred embodiment of the upper water outlet. The preferred tube may comprise a translucent or transparent wall or wall portion for indicating the level of the water table inside the container. The preferred tube is received by a bore in a frame that holds the container, so that the tube, although it is outside the container, is shielded or sheltered by being distanced from the outer extremity of the planter.

The drainage system may be adjusted and used by the gardener to control the water conditions inside the container, that is, to operate either in a “dripping-drain” mode, or in a “dripless” water-table-creating mode, as desired for various gardening situations. When one or more cleanout is/are opened, for dripping-drain mode of operation, excess water drips out of, and does not form a water table in, the container. The water drips to the ground, but, because of the space between the preferably-wheeled planter and the ground or patio, it typically evaporates rather than forming a constantly-wet area beneath the planter. When the cleanout(s) are closed, a water table may be created inside the container, but the water table level is limited by the height of the open end of the tube. Because the open end of the tube is preferably located a short distance above the bottom wall of the container relative to the entire depth of the container, “over-watering” creates only a limited water table that may be beneficial, for example, for mature plants in dry climates. Thus, in the dripless mode of operation, the preferred drainage system allows beneficial over-watering to create a limited water table into which the deep roots of a plant may tap, but does not allow undesirable over-watering, that is, creation of a water table so high that it soaks, and may rot, the upper, main roots of the plants.

The planter preferably comprises wheels for easy moving of the planter. This way, the planter may be rearranged on a patio or moved in and out of the sun, shade and/or cold, for example. The wheels lift the container-frame combination a distance above the patio surface to create a space that receives substantially all of the preferred drainage system.

The planter also preferably comprises a plant support, which may extend several feet above the container, for supporting the plant growing in the container. The plant support may be attachable and detachable depending on the needs of the gardener.

### BRIEF DESCRIPTION OF THE DRAWINGS

FIG. 1 is a perspective view of the preferred embodiment of the invented planter, wherein a cylindrical plant support is installed on the frame of the planter. Portions of the preferred water level sight tube and one drain pipe cleanout are visible beside and below the plant container and frame, while most of the drainage system is hidden below the plant container and frame, and, thus, is shown in dashed lines.

FIG. 2 is a perspective view of the frame of the embodiment of FIG. 1.

FIG. 3 is a cross-sectional, perspective view of the embodiment of FIG. 1, with the plant support detached, and an exploded view of the drainage system.

FIG. 4 is a side, cross-sectional view of the embodiment of FIG. 1, including soil and the plant support. A water table inside the plant container is shown in this drawing, with the water level inside the water level sight tube matching the water table level, and therefore indicating the water table level to the gardener.

FIG. 5 is a perspective view of the preferred drainage system of FIGS. 1, 3, and 4.

FIG. 6 is a perspective, exploded view of the drainage system of FIGS. 1 and 3-5.

### DESCRIPTION OF THE PREFERRED EMBODIMENT

Objects of the preferred embodiment include overcoming the typical deficiencies of both traditional planters and the complex alternative planters. The preferred embodiment provides a large container for soil and plants (hereafter, called a “plant container”), effective water drainage and soil retention, water level indication for excellent water table control, and efficient cleanout capability. In addition, all the aforementioned desirable characteristics are obtained with surprisingly simple, light-weight, and easy to operate and maintain apparatus.

A typical deficiency of the traditional planter is the water drain hole that allows water to drain directly out the bottom of the planter, thereby taking soil with it. “Directly” in this context means that the water drains substantially vertically down through the drain hole, with no structure between the soil and the drain hole to retain the soil in the planter. To avoid soil loss, the home remedy is to cover the drain hole inside the planter with pieces of broken pottery or rocks to block the direct flow of water out the drain hole, thereby preventing the loss of soil. To solve this deficiency, the preferred embodiment of the present invention comprises a raised drain cap, the top surface of which blocks direct flow of water through the drain hole. Multiple small holes in a vertical sidewall(s) of the raised drain cap allow water to flow out of the container indirectly, thus preventing the loss of soil. “Indirectly” in this context means wall structure between the soil and the drain hole that redirects water flow to be substantially horizontal for a time, which, combined with the preferred multiple small holes spaced around the drain cap, serves to retain the soil.

The term “soil,” which is used for simplicity in this disclosure and in the claims, means plant growth media of manly different compositions, plus any active or inert additives that may be desired by the gardener. For example, “soil” may include one or more of the following: plant growth media such as dirt, potting soil, mulch, other natural or artificial plant growth media, and mixtures or layers of the same; active additives such as fertilizers and plant foods; and generally inert additives such as gravel, pebbles, stones, or sand. Unless otherwise specified, therefore, the term “soil” includes all plant growth media, active additives, and/or generally inert additives that are placed in the plant container for surrounding, supporting, and nurturing the plant root system, as will be understood by those of skill in the art.

A typical deficiency of the traditional planter is that the only way to know when the planter is being over-watered is to observe the excess water dripping out the drain hole or a pool of water on the surface underneath the planter. Excess water dripping out the drain hole upon each watering event produces an undesirable mess below the planter and can cause moisture damage to the surface that supports the planter. The home remedy is to purchase an overflow reservoir, such as a tray, for a traditional planter, or to purchase a planter that comes with a reservoir. Still, such reservoirs, whether purchased with the planter or as an afterthought, can overflow. To solve this deficiency, the preferred embodiment of the present invention comprises a drainage system that can be placed in dripless mode, and that incorporates a water level sight tube that allows the gardener to detect when excess water begins to collect on the bottom surface of the plant container. The gardener may efficiently cease watering by visual cue without having excess water escape the planter.

Another typical deficiency of the traditional planter is the lack of a support structure for the plant growing therein, which presents itself most notably when growing vegetable plants. To support the plant, the home remedy is to either build your own support structure or purchase various ready-made support products. Plant support remedies range from the use of bamboo sticks and string to the use of wire support cages such as the conical wire cages designed for use by tomato gardeners. To solve this deficiency, the preferred embodiment of the present invention comprises a rigid plant support that surrounds the growing plant. The plant support has an open grid construction with openings large enough to allow the gardener access to the plant as it grows and allow the easy removal of ripe vegetables when the plant matures. The open grid construction allows the branches of a plant to grow through the grid in order to support itself by resting on the grid. The open grid construction allows a vining plant to attach itself directly to the grid for support. The plant support is detachable if the gardener decides to grow a plant that does not require support.

Another typical deficiency of the traditional planter is that as the size of the planter increases, the ease of movement of the planter decreases. The weight of the soil required to fill the largest traditional planters can easily approach 100 pounds, thereby making the planter difficult to move. The added size and weight of a mature plant growing in wet soil can make moving the planter even more difficult, even in small-sized planters. Most traditional planters are not designed to be moved and can be easily damaged due to the forces applied to the planter during the moving process. For example, lifting or sliding a traditional planter can cause its sides to crack or break depending on the strength of the material used to construct the planter. The home remedy is to place a dolly under the planter to provide mobility, but the planter and dolly combination can become unstable when moving because they are not designed to move as a cohesive unit. To solve this deficiency, the preferred embodiment of the present invention comprises a rigid rolling frame that supports the plant container and the plant support, and that preferably extends along at least five sides (four sides plus the bottom) of the plant container. The preferred embodiment is designed to move as a single, cohesive unit that can withstand the moving forces applied to it as well as support the weight of the contents being carried therein.

A feature of the preferred embodiment not found in traditional planters is the ability to create a water table inside the planter. A typical traditional planter can not maintain an over-watered condition. Once the soil in the traditional planter becomes saturated, the excess water drips out the drain hole and is lost. Some gardeners may want to over-water a mature plant so the plant can feed on the excess water in the soil over an extended period of time. The preferred embodiment comprises a drainage system that is capable of being operated in a dripless mode wherein the gardener may create a water table in the bottom of the plant container. The sight tube extends vertically above the bottom surface of the plant container and confines excess water in the plant container, while allowing a user to view the level of water in the sight tube that corresponds to the level of the water table formed by the excess water inside the plant container. When the level of the water exceeds the length of the sight tube, the open end of the sight tube then acts as a drain, thereby limiting the water table level in the plant container to the height of the sight tube. The sight tube shows the level of the water table dropping as the plant consumes the excess water. The drainage system may comprise drain pipe cleanouts that can be opened to release the excess water in the planter if the gardener wishes to eliminate or prevent the water table, thereby converting the drainage system to a dripping drain.

The preferred embodiment is designed to provide a planter that allows the gardener to grow plants that reach maturity and produce fruit yields similar to plants grown in the ground. The ability of the gardener, to achieve plant quality that mimics that of plants grown in the ground, increases as the size of the planter increases. Growth statistics printed on vegetable plant seed packets, for example, are based on plants grown in the ground and assume the roots of the maturing plants are not constrained. Small planters can stunt plant growth due to the plant becoming root-bound in the planter. For example, a tomato plant growing in a small planter may yield 5 tomatoes, whereas the same tomato plant grown in the ground or a suitably large planter may yield 50 tomatoes. The preferred embodiment comprises a plant container large enough to accommodate the root systems of the largest vegetable plants, such as large-variety tomato plants. The preferred plant container holds generally 6-7 cubic feet of soil and has height, width, and depth dimensions each generally approaching, but preferably not exceeding, two feet.

The preferred embodiment is designed to provide the gardener with planting capabilities superior to plants grown in the ground and plants grown in large traditional planters. Since plants grown in the ground and plants grown in large traditional planters can not be moved, they are susceptible to weather conditions. The mobility of the present invention allows the gardener to move the plant to a safe location, if available, to avoid inclement weather, such as hail storms or freezing temperatures. The gardener can also move the plant to take advantage of the changing sunlight patterns during the span of the growing season. The preferred embodiment is designed for use in locations that provide hard, level ground surfaces, for example, exterior locations such as home patios, balconies, or decks, and interior locations such as the floor of a greenhouse, shed, or garage. The term “ground” used in this disclosure and in the claims means any surface that supports the mobile planter, and may include earthen or other natural surfaces, patios, balconies, decks, driveways, sidewalks, floors, or other generally horizontal surfaces. Hard and generally even surfaces are preferred, as the preferred wheels will tend not to dig into or be impeded by such surfaces.

Preferably the entire interior space of the plant container is available for containing soil and plants, and the plant container is not sub-divided into a soil compartment and a water-containing compartment(s). Thus, the preferred plant container comprises only a single interior space (a single interior compartment or chamber), does not have partition walls extending across the interior of the plant container, and does not have a compartment(s) dedicated to automatic watering, complex drainage, stick/ball float indicator or other complex water monitoring. Except for the drain cap assembly, the entire drainage system, including the sight tube, is provided outside and below the plant container, or, in the case of the sight tube, outside and closely adjacent to the outer side surface of the plant container. The only portions of the drainage system that are typically visible to the gardener or other observers are the sight tube and one drain pipe cleanout of the drain pipe assembly, which are relatively small and inconspicuous compared to the large plant container.

Now referring specifically to the drawings, the invention is shown in its preferred, but not its only, form, which is described below in detail. It should be understood, however, that there is no intention to limit the invention to the specific form disclosed in the drawings, but, on the contrary, the invention is to cover all modifications, alternative constructions, and equivalents falling within the spirit and scope of the invention as defined in the claims.

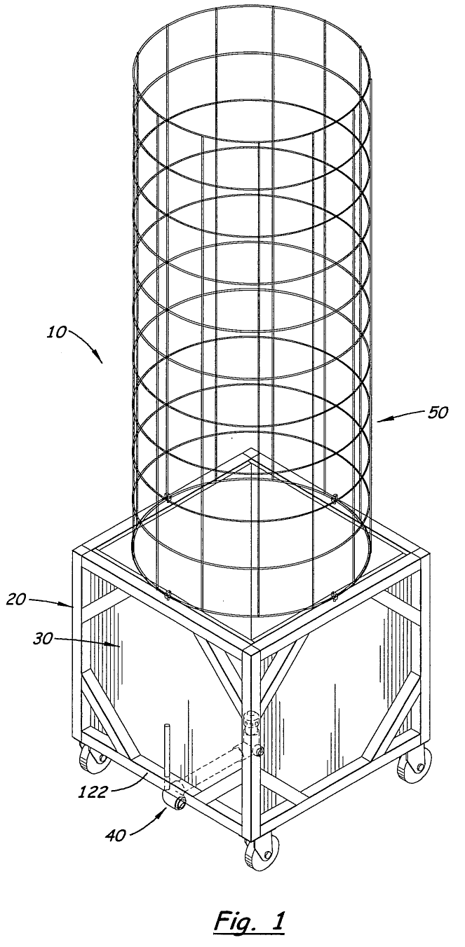

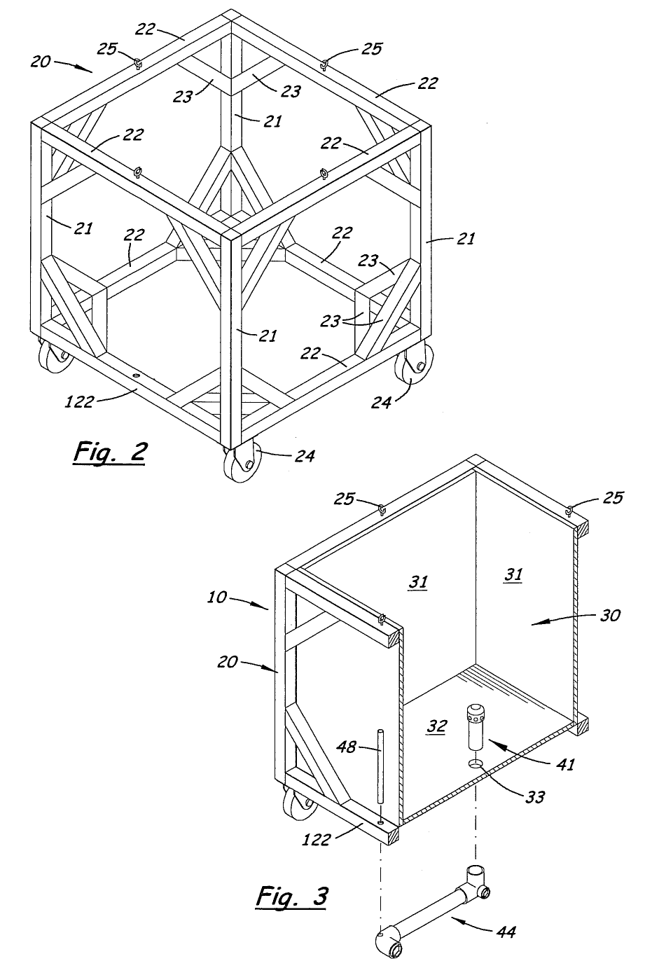

As shown in FIG. 1, the preferred embodiment is a mobile planter 10 comprised of a frame 20, a plant container 30, a drainage system 40, and a plant support 50. While the preferred drainage system 40 may serve in drainage, water table level control, and water level indicating functions, it is hereafter called the “drainage system” for simplicity.

The frame 20 provides the support structure and the mobility means for the mobile planter 10. The frame 20 is comprised of a plurality of corner posts 21, a plurality of beams 22, 122, a plurality of corner braces 23, a plurality of wheels 24, and a plurality of plant support connectors 25. The corner posts 21, beams 22, 122, and corner braces 23 are derived from the same uniform square dimensional rigid building material. The vertical corner posts 21 are interconnected with the horizontal beams 22, 122 to form a rectilinear box framework open at its top. The corner braces 23 are connected in each corner of the four-sided vertical sidewall and each corner of the bottom wall of the rectilinear box framework to provide structural rigidity. The top side of the frame 20 is defined as open due to the absence of corner bracing. The wheels 24 are fastened to the bottom surface of the frame 20 to provide the mobility means, and, in doing so, also provide space between the combination, of frame and plant container, and the ground for receiving the preferred drainage system 40 (discussed in detail later in this document). The plant support connectors 25 are fastened to the top surface of the frame 20 to provide attachment points for the plant support 50. Alternatively, but less preferably, the plant support connectors 25 may be attached to an upper portion of the plant container 30 rather than to the frame 20. Each plant support connector 25 is preferably an eyelet structure comprising an open slot that allows the bottom edge of the plant support 50 to slide into, rest inside, and be supported by the eyelet structure as shown in FIG. 1.

The plant container 30 serves as the chamber for holding a quantity of soil 70 and, eventually, the plant growing therein. The plant container 30 is comprised of a plurality of portions of sidewall 31 and a bottom wall 32 having a drain hole 33. The top side of the plant container 30 is open. The plant container 30 is inserted into the frame 20 and is supported by the corner braces 23 that comprise the bottom wall of the frame 20. The width dimensions of the plant container 30 are less than, but in close tolerance to, the internal width dimensions of the frame 20 allowing the plant container 30 to fit snugly inside the frame 20. The height of the plant container 30 is such that the top surface of the plant container 30 is generally level with the top surface of the frame 20. The sidewall 31 portions are fastened to the horizontal beams 22 that comprise the top surface of the frame 20 to prevent the plant container 30 from sliding out of the frame 20 if the mobile planter 10 is turned upside down.

The plant container 30 in its entirety is preferably single-walled, and may be made from a single material or from layered or composite materials. Preferably, the sidewall 31 and bottom wall 32 of the plant container 30 are waterproof. The plant container 30 sidewall 31 and bottom wall 32 may be opaque and the plant container 30 requires no means for viewing the soil 70, roots, or water that are inside the plant container except that the gardener may look into the plant container through the preferably-open top.

While the preferred plant container sidewall 31 comprises four portions connected to the bottom wall 32 to form a square, open-topped box, other shapes for the plant container 30 and/or frame 20 may be used. For example, the plant container sidewall may be cylindrical or other shapes as desired, with the frame preferably being the same shape as the plant container for support of the plant container and its heavy contents.

Alternatively, the strength afforded by the frame 30 may be provided instead by reinforcement within the plant container or by providing an integrally and inherently strong plant container sidewall. Thus, a single, unitary plant container may be used, rather than a plant container inside a frame, but it will be appreciated that the frame 20 plus single-walled plant container 30 combination provides a system with great strength for holding a large volume of soil and plants and for withstanding pushing or pulling by the user moving the mobile planter 10. Further, the frame 20 is desirable for its role as a connection and shielding structure for the preferred water level sight tube 48, as is discussed in more detail later in this document.

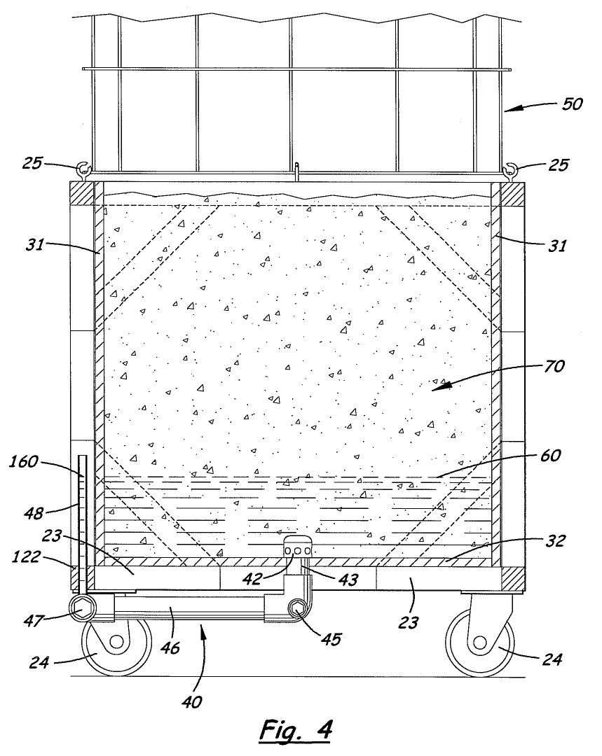

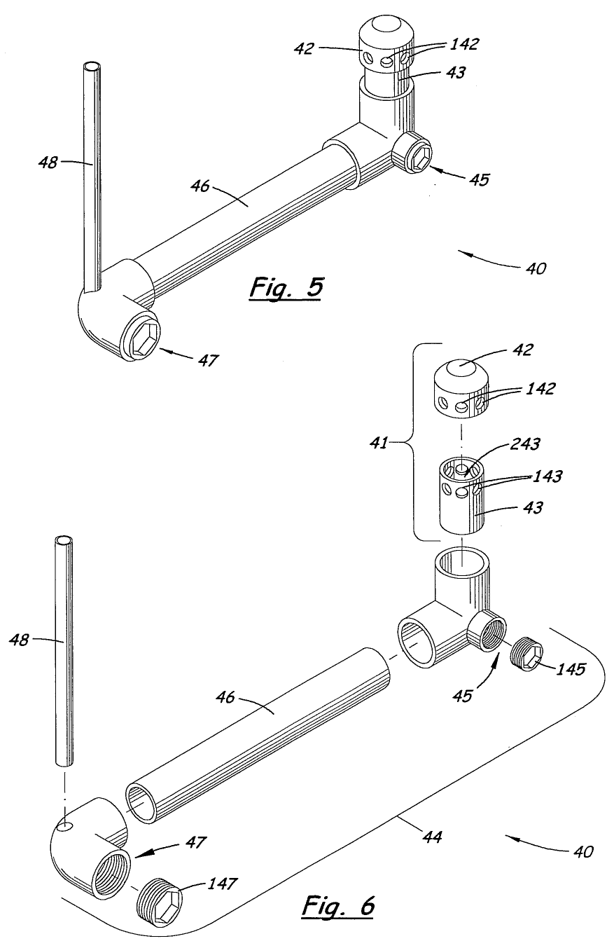

The drainage system 40 provides means to confine excess water inside the plant container 30, thereby forming a water table within the soil 70 contained therein. The drainage system 40 also provides means to allow water to drain out of the plant container 30, to prevent excess water from accumulating therein. The preferred drainage system 40 is comprised of a drain cap assembly 41, a drain pipe assembly 44, and a water level sight tube 48 (hereafter, “sight tube 48”), as shown to best advantage in FIGS. 4-6. The drain cap assembly 41 is comprised of a drain cap 42 connected to a drain cap downtube 43 (hereafter, “downtube 43”). The drain pipe assembly 44 is comprised of a first drain pipe cleanout 45 (hereafter, “first cleanout 45”), a drain pipe 46, and a second drain pipe cleanout 47 (hereafter, “second cleanout 47”). The preferred downtube 43, drain pipe 46, and sight tube 48 may be described as being straight, tubular conduits.

The drain cap assembly 41 is inserted vertically through and fastened to the drain hole 33, for example, by epoxy or other water-proof adhesive or sealant, so that all water leaving the plant container 30 leaves by means of the multiple small holes 142 (hereafter, “holes 142”) spaced around the vertical cylindrical side of the drain cap 42. Preferably, the drain cap 42 lower edge contacts and is sealed to the upper surface of the bottom wall 32, with the upper end of the downtube 43 inside the drain cap 42 but not visible from the inside of the plant container 30. Preferably, the holes 142 line up with, and fluidly communicate with an equal number of small holes 143 in the upper end of the downtube 43, so that the water leaving the plant container 30 flows through said holes 142, into said holes 143, and into the hollow passage 243 of downtube 43 in order to reach drain pipe 46.

The downtube 43 is connected to the first cleanout 45 of the drain pipe assembly 44, which may take the form of an elbow having an aperture threaded to cooperate with threaded plug 145. The drain pipe assembly 44 is oriented generally horizontal and parallel to the bottom surface of the frame 20. The drain pipe assembly 44 is terminated by the second cleanout 47, which may take the form of an elbow having an aperture threaded to cooperate with threaded plug 147. Second cleanout 47 resides directly beneath one of the beams 122 forming the bottom of the frame 20. The read-sealing tape may be used with each of the threaded plugs, 145, 147.

The sight tube 48 connects to the second cleanout 47 and passes vertically upward through an access bore in the beam 122 of the frame 20. The sight tube 48 preferably comprises a length of generally translucent, rigid, open-ended tubing that terminates above the level of the bottom wall 32. Alternatively, instead of a cylindrical sight tube 48, other shapes of hollow water level indicators may be used, including non-cylindrical members such as rectangular- or oval-transverse-cross-section members. Therefore, in this disclosure and claims, the term “hollow water level indicator” means any member that has a vertical height and at least a portion extending the full vertical height, but wherein said at least a portion does not necessarily extend vertically straight but may curve or bend, and wherein said hollow water level indicator is not necessary cylindrical.

The sight tube 48 provides a visible indication, by means of water surface 160, of where a water table level 60 inside the plant container 30 resides relative to the top surface of the bottom wall 32, as seen in FIG. 4. The height of the sight tube 48 defines the maximum level of water allowed in the plant container 30 before the open end of the sight tube 48 acts as a drain for excess water, by means of water spilling over the open end of the sight tube 48. The sight tube 48 is preferably the only means for indicating or viewing the water level inside the plant container 30.

It may be noted that, by having the sight tube 48 extend vertically upward through a portion of the frame 20 to be closely adjacent the exterior surface of the sidewall 31 of the plant container 30, the outermost horizontal extremity of the mobile planter 10 is the frame 20, rather than the sight tube 48 or the drainage system 40. Thus, the sight tube 48 is inward relative to said outermost horizontal extremity. In this position, the sight tube 48 is generally shielded by beam 122, so that it is less likely to be broken or to become caught on other objects or the gardener or other user's clothing. This way, the sight tube 48 is stabilized, protected, out of the way, and yet visible.

Opening of at least one of said first or second cleanout (45 or 47) allows excess water to drain out of the plant container 30 at a location(s) lower than the lowest portion of the interior space of the plant container 30, thereby preventing the formation of a water table. Also, the opening of both of said first and second cleanouts (45 and 47) allows the drain pipe 46 to be cleaned out by, for example, allowing water to be flushed through the drain pipe 46 thereby purging debris and sediment from the drain pipe 46. Debris and sediment may be cleaned out of the drain pipe assembly 44 by opening both of said first and second cleanouts 45, 47 and directing a flow of water into the first cleanout 45, thereby pushing debris and sediment out the second cleanout 47.

The preferred embodiment allows for watering from the top by conventional means, and does not require any water source or equipment other than a garden hose or natural rainfall, for example, and does not require any water drip, wick, or hose water supply system inside the plant container. No flexible tubing is needed in, or connected to, the mobile planter 10, except that a standard garden hose may be held by the gardener when watering. The mobile planter 10 preferably does not comprise any wick watering system, as it is expected that effective wicking material made of biodegradable natural fibers would soon deteriorate inside the soil 70 in the plant container 30. Preferably, no apparatus is inside the plant container 30 except for the drain cap 42, the upper end of downtube 43, soil 70, and plants.

The plant container 30 need not comprise large reservoirs of excess water, and especially need not comprise large reservoirs that are empty except for the water. The drainage system 40, preferably comprising drain cap assembly 41, drain pipe assembly 44, and sight tube 48, is the only apparatus that will contain water and little or nothing else. As discussed above, the preferred assemblies 41, 44 and sight tube 48 may all be described as tubular and have very small diameters compared to the width and depth, or diameter, of the plant container. Therefore, only a small volume of excess water is contained in the drainage system 40 and all other excess water is preferably located in the soil 70. The internal volume of the drainage system 40 is equal to only a very small fraction of the internal volume of the plant container 30; the volume of the drainage system 40, and, hence, the maximum volume of excess water contained in the drainage system, is preferably less than 1/500^{th}, and more preferably on the order of 1/1000^{th}, the volume of the interior space of the plant container 30. Thus, it may be said that the maximum volume of water that may be contained in the drainage system 40, that is, when the drainage system 40 is full, is very small compared to the volume of soil 70 typically provided in the plant container 30 and also very small compared to the volume of water of the maximum water table that may be established in the plant container 30.

The only portions of the drainage system 40 that reside inside the plant container 30 are the drain cap 42 and upper end of the downtube 43, and these are the only structures that may be said to provide or comprise vacant space (in drip-drain mode) or open space containing only water (in dripless mode) inside the plant container 30. These portions, however, only represent a very small volume compared to the entire plant container 30 interior space and cover only a very small fraction of the bottom wall 32. For example, the interior volume of the drain cap 42 is on the order of about 1/10,000^{th} of the volume of the plant container 30. Also, for example, the drain cap 42 horizontal cross-sectional area, measured at its largest diameter, is preferably less than 1/200^{th}, and more preferably on the order of about 1/500^{th}, of the area of the bottom wall 32. Preferably, the soil 70 extends all the way down to the upper surface of the bottom wall 32 of the plant container 30, all the way around the drain cap 42.

The preferred drainage system 40 extends through the preferred single-walled bottom wall 32 and is the only conduit for water to pass through the plant container walls (sidewall 31 or bottom wall 32). As described above, the preferred drainage system 40 may be made from easily-available commercial components, preferably plumbing components made of hard plastic. While separate components may be connected and sealed to each other to form the preferred drainage system 40, alternative drainage systems may be substantially integrally molded or otherwise integrally formed, so that minimal connection and sealing of components is required. It may be noted, however, that the preferred drain cap 42 and the elbow forming the first cleanout 45 are both larger in diameter than the hole 33 in the bottom wall 32, so that installation of the preferred drainage system comprises connection of the drain cap assembly 41 to the elbow of the first cleanout 45 after the drain pipe assembly 44 has been placed beneath the plant container 30 and frame 20 and after the drain cap assembly has been inserted into the hole 33 from inside the plant container 30.

Preferably, all of the drainage system 40 (including drain cap 42, downtube 43, drain pipe 46, and first and second cleanouts 45, 47) are cylindrical in form, and of small diameter relative to the much larger dimensions of the plant container 30. Less preferably, non-cylindrical hollow members may be used in the drainage system, but, in such embodiments, it is still desired that the transverse cross-sectional dimensions and internal volume of the drainage system be much smaller than the much larger dimensions and volume of the plant container 30.

The plant support 50 provides support for the plant that eventually grows to maturity within the soil 70. The preferred plant support 50 is configured as a cylinder open at both ends comprised of generally rigid and resilient wire that extends high above the plant container, and typically has a height 1-3 times the height of the plant container 30, for example.

The plant support 50 is attached to the frame 20 by resting the bottom edge/wire of the plant support 50 inside the plant support connectors 25 (hereafter, “connectors 25”). The plant support 50 can be easily detached from the frame 20 by reversing the attachment procedure. Each of the preferred connectors 25 comprises an “open eyelet” that is a semi-circular hook with an opening into the interior space of the hook. The openings of all the connectors 25 preferably face inward. The plant support 50 and connectors 25 are sized and located to cooperate in such a way that the bottom wire of the plant support 50 will rest in the interior spaces of all of the connectors 25 at the same time and will be unlikely to slide out of the hook openings. Ideally, the shape, size, and resiliency of the plant support 50 will tend to center the bottom wire in the lower portion of the interior spaces of the hooks and/or cause the bottom wire to press outward against the closed sides of the hooks, so that the bottom wire, in effect, snaps into the connectors 25 and is unlikely to fall out of the hooks. Thus, the plant support 50 is preferably removably captured in the preferred open-eyelet or hook-shaped connectors 25, but may instead be captured or fastened by other connectors, fasteners, or latches.

Some embodiments of the invented mobile planter may be described as consisting essentially of, or consisting of: a plant container with a flame; a drainage system comprising a drain cap assembly having holes in a vertical surface, a generally horizontal drain pipe assembly with at least one cleanout, and a generally vertical sight tube; and a preferred, but optional, plant support. Said generally vertical tube preferably is adapted to provide a water outlet exterior to the plant container at a level, above the plant container bottom wall, that is about ¼-⅓ of the way up the side of the plant container, and also preferably is adapted to allow viewing of the water table inside the plant container. The drain cap assembly may be described as consisting essentially of, or consisting of, a cap and a generally vertical downtube. The drain pipe assembly may be described as a pipe with elbows on each end, the elbows having apertures with threaded plugs. The generally vertical sight tube may be described as consisting essentially of, or consisting of, a single transparent hollow member, which is preferably a cylindrical tube. Such simple embodiments of the invention may be economical and extremely effective, as they are easy to use, clean, and maintain.

Other embodiments of the invention will be apparent to one of skill in the art after reading this disclosure and viewing the drawings. Although this invention is described herein and in the drawings with reference to particular means, materials and embodiments, it is to be understood that the invention is not limited to these disclosed particulars, but extends instead to all equivalents within the scope of the following claims.

1. A gardening planter comprising:
a frame;
a plant container supported by the frame and having a bottom wall and a sidewall defining an internal chamber for holding soil and plants, wherein said bottom wall has at least one hole and has a top surface on a bottom wall plane;
a drainage system fluidly connected to said internal chamber for allowing excess water in said plant container to drain out of the plant container, said drainage system comprising:
a drain cap assembly in the internal chamber and extending through said at least one hole, the drain cap assembly having a drain cap positioned inside the internal chamber and comprises a vertical wall having a plurality of drain holes;
a drain pipe assembly connected to said drain cap assembly and fluidly communicating with said plurality of drain holes, the drain pipe assembly being outside and below the plant container and extending generally parallel to the bottom wall of said plant container to a location near the sidewall of said plant container; and
a sight tube connected to, and fluidly communicating with, said drain pipe assembly, wherein the sight tube extends upwards along an outer surface of said sidewall and terminates at an open distal end that is outside of the plant container and on a horizontal distal end plane that is above said bottom wall plane, wherein, when a water table level within the internal chamber is above said horizontal distal end plane, water from the internal chamber flows through the drain pipe assembly and to the sight tube and out of said open distal end, and wherein at least a portion of the sight tube is generally translucent to allow a user to observe a level of water in the sight tube and generally determine the water table level in said internal chamber.

2. The planter of claim 1, wherein said drainage system further comprises at least one cleanout aperture in said drain pipe assembly at a level below the bottom wall of the plant container, and a threaded plug removable from said at least one cleanout aperture for draining of water out of the plant container to eliminate the water table inside the internal chamber.

3. The planter of claim 1, wherein said sight tube extends upwards along an outer surface of said sidewall by extending through a bore in a portion of the frame that protrudes horizontally outward farther than the sidewall of the plant container.

4. The planter of claim 1, further comprising at least one upright plant support connecting to an upper surface of said frame, wherein a lower edge of said plant support is removably captured by a plurality of fasteners fixed to the frame by means of the lower edge snapping into an interior space of each fastener through an opening in each fastener.

5. The planter of claim 1, further comprising at least one upright plant support connected to an upper surface of said plant container, wherein a lower edge of said plant support is removably captured by a plurality of fasteners fixed to the plant container by means of the lower edge snapping into an interior space of each fastener through an opening in each fastener.

6. The planter of claim 1, wherein said frame has at least one corner brace configured for supporting said bottom wall, and wherein said frame has a bottom surface having a plurality of wheels adapted to rollably support the frame and plant container a distance above a supporting surface to provide a space underneath the frame and the plant container for receiving said drainage system.

7. The planter of claim 1, wherein said drain pipe assembly comprises two drain cleanouts generally at opposite ends of the drain pipe assembly, each of the drain cleanouts comprising an aperture and a threaded plug removable from its respective aperture, so that the two drain cleanouts are adapted for cleaning said drain pipe assembly when water is directed into the aperture of one of said two drain cleanouts to push debris and sediment out of the aperture of the other of said two drain cleanouts.

8. The planter of claim 1, wherein said sidewall and said bottom wall are each single-walled and the plant container comprises only one internal chamber.

9. The planter of claim 1, wherein said plant container comprises no reservoir that holds water except for said internal chamber holding said water table.

10. The planter of claim 1, comprising no excess water reservoir outside of said internal chamber except for interior spaces of said drain cap assembly, drain pipe assembly, and said sight tube.

12. The planter of claim 1, wherein said drain cap, said drain pipe assembly, and said sight tube are each cylindrical.

13. The planter of claim 1, wherein all of the drainage system is below the frame and plant container except for said sight tube.

14. The planter of claim 1, wherein said sight tube is separated from the plant container along its entire length.

15. A planter for growing plants, the planter comprising:
a plant container with an interior space for receiving soil and plants, the plant container having a bottom wall and a sidewall;
a drainage system comprising:
a cap assembly inside said interior space and extending down through a hole in a bottom wall of the planter container;
a drain pipe assembly connected to and fluidly communicating with the cap assembly and extending horizontally along an outer surface of the bottom wall of the plant container to near the sidewall; and
a hollow water level indicator fluidly communicating with said drain pipe assembly and extending generally vertically up along, but not attached to and not contacting, said sidewall to a location between the bottom wall and a top edge of the plant container, wherein the water level indicator is defined by an indicator wall that has at least a portion that is translucent or transparent so that water inside the water level indicator is visible from outside the water level indicator, the water level indicator having an open top end for spilling water out of the drainage system over a top edge of said water level indicator.

16. The planter as in claim 15, wherein said water level indicator is a cylindrical tube.

17. The planter as in claim 15, wherein said water level indicator is a hollow, translucent tube.

18. The planter as in claim 15, further comprising a frame around the plant container, and wherein said frame comprises a beam extending along a lower edge of the plant container, wherein said water level indicator extends through a bore in said beam to extend generally vertically along the sidewall.

19. The planter as in claim 18, having a vertical centerline inside said plant container, wherein said beam is a horizontal outermost extremity of the planter, and wherein the water level indicator is located in a position outside of said sidewall and inward relative to said outermost extremity.

20. The planter as in claim 18, wherein said drain system is connected to the plant container and the frame only at said hole in the bottom wall and at said bore through said beam.

21. The planter as in claim 20, wherein said frame comprises wheels that lift the frame and plant container up to form a space between the frame and the plant container and a surface supporting the wheels, the drain pipe assembly being located in said space.

22. The planter as in claim 21, wherein the plant container has a depth, and the planter further comprising a plant support connected to said frame, the plant support extending up from the plant container a distance equal to 1-3 times said depth.
